(19) United States
(12) Patent Application Publication
(10) Pub. No.: US 2007/0009871 A1
(43) Pub. Date: Jan. 11, 2007

(54) System and method for improved cumulative assessment

(75) Inventors: Sylvia Tidwell-Scheuring, Carmel, CA (US); Daniel Lewis, Carmel, CA (US)

Correspondence Address: ROTHWELL, FIGG, ERNST & MANBECK, P.C., 1425 K STREET, N.W., SUITE 800, WASHINGTON, DC, 20005, US

(73) Assignee: CTB/MCGRAW-HILL, Monterey, CA (US)

(21) Appl. No.: 11/441,449

(22) Filed: May 26, 2006

Related U.S. Application Data
(60) Provisional application No. 60/689,978, filed on May 28, 2005.

(51) Int. Cl. G09B 3/00

(52) U.S. Cl. 434/350

(57) ABSTRACT

A system and method for improved cumulative assessment provide for automatically, e.g., programmatically, determining an evaluation of two or more assessments including two or more related items in a cumulative manner. In one embodiment, an initial assessment including initial assessment items is administered at time T1 and scored to produce an ability estimate. At least one successive assessment is also administered and scored to produce an ability estimate. Selected ones of the administered assessments or included items are determined (“included assessments”), and the included assessments are scored to produce a simultaneous maximum likelihood ability estimate for the included assessments, for example, in view of all of the included assessments.

This application claims the benefit of U.S. Provisional Application Ser. No. 60/689,978 filed May 28, 2005, the contents of which are hereby incorporated by reference.

### BACKGROUND OF THE INVENTION

1. Field of Invention

The present invention relates in general to the field of education and more specifically to systems and methods for conducting test assessment.

2. Description of the Background Art

Conventional assessment provides for a administering a variety of different individualized tests in which each test is designed to assess a particular subset of various aspects of student learning. While final scores may be compared, each test is configured in a distinct and encapsulated manner for separately assessing the particular learning aspects of a particular student.

Formative testing, for example, provides for relatively frequent, less formalized testing of ongoing student progress in one or more particular aspects of a particular learning area. Formative testing may, for example, include a weekly testing of recently covered topics in mathematics or other separately formulated periodic testing of recently covered topics in science, and so on. Each formative test is typically highly encapsulated with regard to the topic and any sub-topics to be covered, as well as with regard to the construction and goal (or “call”) of included test items. Assessing of each formative test is also highly encapsulated. Each test item is separately assessed and accumulated to produce a separately derived test score. While so-called cumulative testing may also be administered (e.g., finals), such testing is also typically provided, administered and assessed in a similar manner as with other formative testing.

Conventional summative testing is nearly entirely distinct from current formative testing in both substantive and procedural respects. Current summative testing provides for very infrequent, highly formalized and more extensive testing of accumulated learning of each student that may cover a particular learning area or collection of learning areas. Summative testing further, need not be limited to recent learning and may instead include less recent learning, learning that may not yet have been achieved (e.g., for testing the extent of student learning, as a result of syllabus variations, and so on). Summative testing items, portions thereof, presentation or goals (e.g., implemented as item response assessment criteria) may also differ extensively from those of formative testing. For example, items may be required to meet increased reliability and validity criteria, minimization of bias criteria, security or exposure criteria and so on. Summative testing may, for example, include achievement tests, professional certification tests, college admissions testing, or other standardized tests that are typically administered following of some period of education, such as the end of a professional program, school year, semester or quarter.

As with formative testing, however, conventional summative testing is typically highly encapsulated. Each summative test is entirely separately evaluated and assessed to produce a summative test score. The separately produced summative test score may then be compared with that of another (typically the immediately preceding) summative test to determine whether a student learning change has occurred (e.g., student knowledge has or has not improved in a particular learning area—typically an area that has been newly presented since the preceding summative test).

Unfortunately, because the formality and comprehensiveness of conventional summative testing often require testing very near the end of a school term and the present testing approach results in very extensive testing, the lengthy process of assessment may not be completed until after the school term has ended. The assessment process may further take months to complete. Such factors, as well as the different nature and increased importance of a particular summative testing session also render summative testing a necessarily disruptive and stressful addition to formative testing to all involved. For example, poor summative testing results may well adversely affect student placement, faculty/institutional evaluation or ranking, financing and/or other factors. The present inventors have also determined that the accuracy and reliability of summative testing as, for example, as a probabilistic assessment of student learning, may be substantially increased. For example, aspects of the present invention enable substantially greater resistance to accuracy concerns, such as a student guessing incorrectly on a first summative test and correctly on a second summative test being mis-interpreted as an indicator of increased learning. Thus, among other conventional testing problems advances promised by the present invention may well draw into question the sufficiency of present summative testing accuracy and reliability.

Accordingly, there is a need for improved cumulative assessment systems and methods that enable one or more of the above and/or other problems of conventional testing to be avoided.

### SUMMARY

Aspects of the invention are embodied in systems, methodologies, software, etc for computing an improved likelihood ability estimate for an assessment respondent or a group of assessment respondents. Assessments are administered to respondents a first time and at least one subsequent time. Responses to items in the assessments are scored each time. Two or more assessments are selected, based on selection criteria, and from the selected assessments, a number of items are selected, also based on selection criteria, to be included in an improved likelihood ability estimate. An improved likelihood ability estimate for each respondent or the group of respondents can be computed based on the selected, or included, assessments and the selected, or included, items.

Accordingly, an improved ability estimate computed in accordance with the cumulative assessment scheme described herein becomes a more integrated assessment based on the respondent's cumulative performance on multiple assessments, as opposed to being merely a snapshot ability estimate based on a single point-in-time assessment.

### BRIEF DESCRIPTION OF THE DRAWINGS

FIG. 1a is a flow diagram illustrating a cumulative assessment system according to an embodiment of the invention;

FIG. 1b is a flow diagram illustrating a further cumulative assessment system according to an embodiment of the invention;

FIG. 2a illustrates a mechanism for performing related item selection in conjunction with cumulative assessment according to an embodiment of the invention

FIG. 2b illustrates another mechanism for performing related item selection in conjunction with cumulative assessment according to an embodiment of the invention;

FIG. 2c illustrates a further mechanism for performing related item selection in conjunction with cumulative assessment according to an embodiment of the invention;

FIG. 3a illustrates utilization of a learning map in performing cumulative assessment according to an embodiment of the invention;

FIG. 4 is a graph illustrating application of cumulative assessment according to an embodiment of the invention;

FIG. 5 is a schematic diagram illustrating an exemplary computing system including one or more of the cumulative assessment systems of FIGS. 1a or 1b, according to an embodiment of the invention; and

FIG. 6 is a flowchart illustrating a cumulative assessment method according to an embodiment of the invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer” for purposes of embodiments of the present invention may include any processor-containing device, such as a mainframe computer, personal computer, laptop, notebook, microcomputer, server, personal data manager or “PIM” (also referred to as a personal information manager or “PIM”) smart cellular or other phone, so-called smart card, settop box or any of the like. A “computer program” may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A “computer-readable medium” for purposes of embodiments of the present invention may be any medium that can contain, store, communicate, propagate, or transport the computer program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

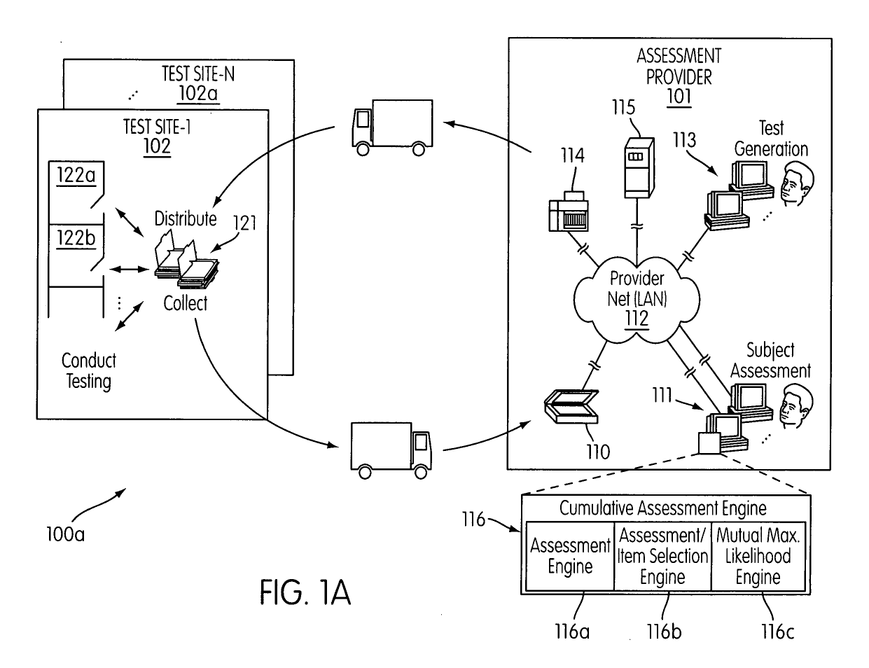

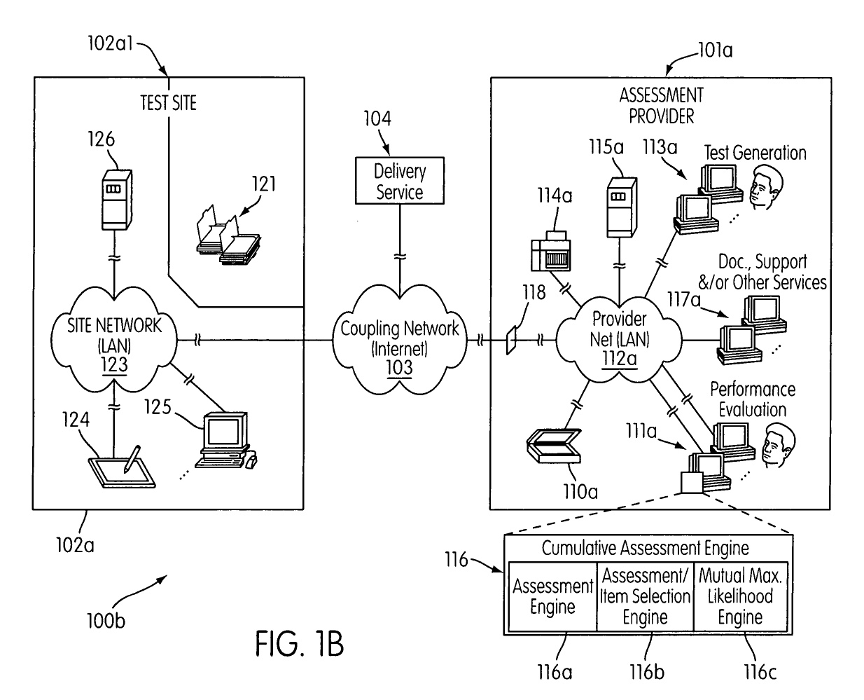

Referring now to FIG. 1a, there is seen a flow diagram illustrating a cumulative assessment system 100a according to an embodiment of the invention. Cumulative assessment system 100a broadly provides for forming a maximum—or at least improved —likelihood ability estimate corresponding to at least one assessment subject (hereinafter “student”) from two or more selectably included assessments, or further, from assessment of selectably included items within the selectable assessments. An assessment may, for example, include one or more of formative, summative or other testing, educational or other gaming, homework or other assigned or assumed tasks, assessable business or other life occurrences, other interactions, and so on. An assessment may further include a complete assessment or some assessment portion such that, for example, a cumulative assessment may be produced from included assessments including two related portions of a same assessment session (e.g., one assessment session portion that includes conventional selected response item portions and another assessment session portion that includes related constrained constructed response or other response portions), or may produced from related but individually administered assessments. An assessment may further include a performance assessment (e.g., scored), a learning assessment (e.g., knowledge, understanding, further materials/training, discussion, and so on), other assessments that may be desirable, or some combination thereof. Assessment may additionally be conducted in a distributed or localized manner or locally or remotely in whole or part or some combination of assessments may be used.

For clarity sake, however, the more specific assessment example of separately administered testing will be used as a consistent example according to which testing (or other assessment) embodiments of the invention may be better understood. It will be appreciated, however, that other assessment mechanisms may be utilized in a substantially similar manner as with separately administered testing.

In separately administered testing, for example, assessment materials (hereinafter, “testing materials”) that may include one or more questions, other response requests or portions thereof (“items”) is presented to one or more students who are charged with producing responses to the items (“item responses”). The items or item portions may, for example, include selected response item portions, in which the students may choose from predetermined presented answers and indicate their answer selection (e.g., in a response grid, in a provided form, and so on.) The items or item portions may also include constrained constructed response (“CCR”) items in which the students may modify or construct a presented graph (“graph item”), circle, cross out, annotate connect, erase, modify or otherwise marking up portions of a presented drawing, text, audio/visual clip(s), other multimedia or combined test materials (“markup item”), delineate a correspondence (“matching item response”) between or among presented images, text, other multimedia or combined test materials (“matching item”), provide missing text, numbers or other information or some combination (“short answer response”), and so on. Other item types, portions thereof or some combination may also comprise items.

Note that the term “or” as used herein is intended to include “and/or” unless otherwise indicated or unless the context clearly dictates otherwise. The term “portion” as used herein is further intended to include “in whole or contiguous or non-contiguous part” which part can include zero or more portion members, unless otherwise indicated or unless the context clearly dictates otherwise. The term “multiple” as used herein is intended to include “two or more” unless otherwise indicated or the context clearly indicates otherwise. The term “multimedia” as used herein may include one or more media types unless otherwise indicated or the context clearly indicates otherwise.

In the more specific embodiment of FIG. 1a, one or more hard copy (e.g., paper) testing materials may be received by a test site 102 and testing may be administered at one or more locations 102a, 102b within test site 102 to one or more test subjects (hereinafter “students”), which are not shown. In the context of the present invention, a test (or assessment) subject, is referred to as a student. The present invention is not, however, limited to application with conventional students, i.e., children, teenagers, and young adults attending elementary, secondary, and post-secondary institutions of learning. In the context of the present invention, a student is any test subject and may also include, for example, occupational trainees or other individuals learning new information and/or skills. The testing materials may, for example, be received from an assessment provider that will assess student responses 101, another assessment provider (not shown) or some combination. One or more versions of the test materials may be delivered to the test site in an otherwise conventional manner and test materials for each student may, for example, include at least one test booklet and at least one answer sheet. Alternatively, a mixed format may be used in which each student is provided with testing materials including an item sheet onto which a student is charged with providing item responses in a space provided or predetermined to be discoverable by the student (“response region”), or other formats or combined formats may be used. (Discovering a response region may also comprise an item response.)

Testing may be administered in an otherwise conventional manner at various locations 122a, 122b within each test site 102, 102a using the received test materials 121. Testing materials including student responses (hereinafter collectively referred to as “student answer sheets” regardless of the type actually used) may then be collected and delivered to subject assessment system 111 of assessment provider 101 for assessment. Other testing materials provided to students, including but not limited to test booklets, scratch paper, and so on, or some combination, may also be collected, for example, in an associated manner with a corresponding student answer sheet, or further delivered to subject assessment system 111, and may also be assessed. (Student markings that may exist on such materials or the lack thereof may, for example, be included in an assessment.)

Assessment provider 101 portion of assessment system 100 in one embodiment comprises a subject assessment system 111 including at least one test material receiving device 110 and a cumulative assessment engine 116. (It will become apparent that assessment of the tests may also be conducted by one or more other subject assessment authorities using one or more assessment engines and selected assessment results or assessments of selected items may be provided to one or more cumulative assessment providing components, or some combination may be used.) Test material receiving device 110 in a more specific embodiment includes a high-speed scanner, brail reader or other mechanism for receiving one or more response portions (e.g., of an answer book) and providing included item responses in an electronic format to other subject assessment system components.

Assessment (i.e., Test) generation system 113 in one embodiment includes item/assessment producing device 114 (e.g., printer, audio/video renderer, and so on, or some combination). Assessment generation system 113 may be further coupled, e.g., via a local area network (LAN) or other network 112, to a server 115. Assessment generation system 113 is also coupled (via network 112) to subject assessment system 111 and item response receiving device 110 (e.g., a scanner, renderer, other data entry device or means, or some combination).

Subject assessment system 111 also includes an assessment/item selection engine (“selection engine”) 116b. Selection engine 116b provides for selecting two or more assessment portions including related items (“included assessments”) or for further selecting assessments of two or more related items (included items) corresponding to two or more assessments based on selection criteria and selection indicators as discussed below. Selection engine 116b may in one embodiment receive predetermined included assessments or included assessment items from a coupled storage storing such information, other subject assessment system 111 component, some other assessment source, or some combination. In another embodiment, selection engine 116b may receive selected assessments from one or more predetermined or otherwise determinable assessment sources to be used in their totality or from which selection engine 116b may select items that are or are not to be further processed in accordance with cumulative assessment (“included items” or “excludable items” respectively). Related items for purposes of the present embodiment may include those items for which an ability assessment may be conducted with respect to a common goal (e.g., measuring mathematical ability, measuring science ability, measuring nursing ability).

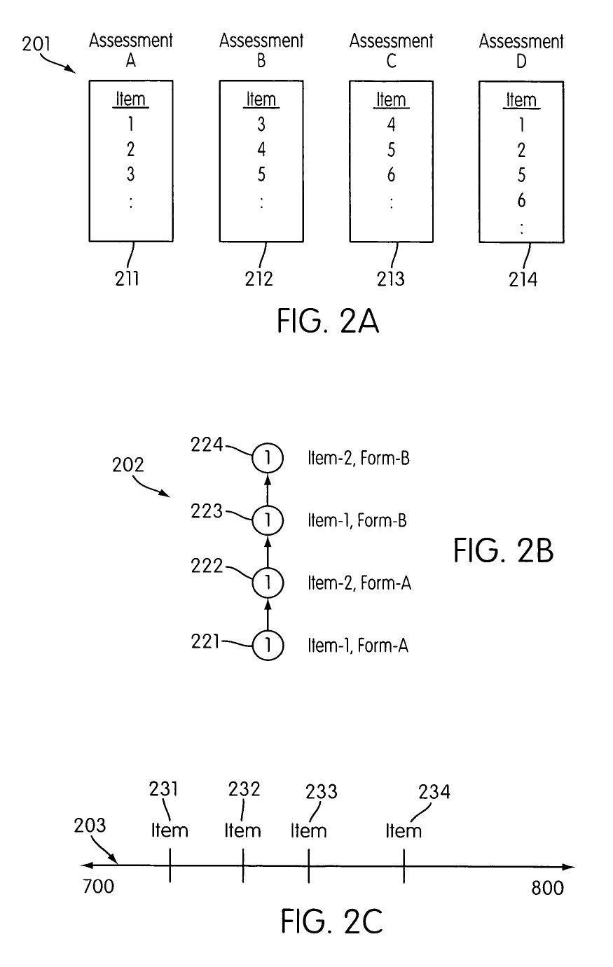

FIGS. 2a through 2C illustrate embodiments of mechanisms according to which selection engine 116b may select related items. In accordance with the illustrated embodiments, selection engine 116b may receive item selection criteria from a coupled storage storing such information, other subject assessment system 111 component, some other assessment source, or some combination. The selection criteria source may, for example, be a predetermined source, an association of such source(s) with one or more assessment information, a source otherwise determinable by selection engine 116b, e.g., in an otherwise conventional manner for selecting a coupled component, or some combination. The selection criteria may further include selection indicators, e.g., for selecting particular items, item groups or portions thereof, selection algorithms, weighted selection, AI, application of learning maps, cluster analysis, and so on, or some combination. One or more similar mechanisms may also be used for selection of one or more assessments or portions thereof. Other selection mechanisms or some combination of selection mechanisms may also be used for conducting selection, selection refinement or both.

Beginning with FIG. 2a (and assuming that received selection criteria are received by selection engine 116b), received assessment information may include an ordering of items within two or more of assessments A through D 201 and item goals corresponding to the items. The selection criteria may further provide indicators for selecting items (e.g., goal importance, assessment results, and so on). A numbering of such goals is indicated by the item numbers for items 211-214. Accordingly, selection engine 116b may select the items according to the indicators or criteria. For example, item 3 of assessment A 211 and item 3 of assessment B 212 are related items relating to a common goal and may correspond with one or more of item indicators or criteria for selecting from among related item alternatives (e.g., a commonly difficult goal to attain, a goal that will be required on a standardized or other assessment, and so on, or some combination).

FIG. 2a also illustrates how embodiments of the present invention enable a series of assessments otherwise provided as formative assessments with respect to substance, procedure or both. (Formative, for purposes of the present invention, may include any ongoing assessment regardless of form. Summative testing may further be defined in a conventional sense, while cumulative testing may provide for producing assessment information otherwise attributable to conventional summative assessment, but may be produced using formative testing, summative testing or both.)

More specifically cumulative testing may include ongoing testing in which the items of any assessment are provided in a standardized manner (e.g., extensive accuracy in identifying a likelihood that a student has acquired an ability or ability level corresponding to a goal) or by a lesser skilled teacher or other item preparer. As will become more apparent, embodiments of the present invention enable substantial improvement in estimation accuracy that may be applicable to either mode of preparation. Additionally, because embodiments of the present invention enable an accumulation of related items that may be distributed over the course of multiple assessments (e.g., at least two), the number of items included in a particular assessment may be decreased.

Cumulative assessment may still further be conducted at various points in time utilizing all or some of available assessments. Thus, for example, assuming that assessments A through D are conducted at successive points in time, cumulative assessment may be conducted following assessment B and in conjunction with assessments A and B to provide a more accurate estimation of a corresponding student's ability with respect to the assessed goals at the time of assessment B as well as at the time of assessment A (e.g., see below). Cumulative assessment may also be conducted following assessment C and in conjunction with one or more of assessment A and assessment B to provide a more accurate estimation of a corresponding student's ability with respect to the goals of included items of included assessments, and so on.

FIG. 2a also illustrates how cumulative assessment according to the present invention enables summative-like testing to be conducted in an expeditious manner. As was noted earlier, any one or more of assessments A through D may be administered—in a more conventional sense—as a formative or summative assessment. However, because cumulative assessment provides for aggregation of related items, accuracy improvement may be achieved in an ongoing manner for summative assessment, formative assessment or both. Therefore, comprehensive final summative assessment is not required and, in addition to response scoring automation or other techniques that may be used, a less comprehensive or extensive final test may administered that may be scored in a more expeditious manner. Nevertheless, it is likely that a final assessment including items covering a greater spread of goals may provide even further accuracy benefits (e.g., by assessing an ability estimate for a student that covers a broader range of goals or goals presented over a broader time period. Thus, for example, Assessment D may include items relating to goals 1 and 2 (e.g., for which learning may have been presented first and second or otherwise during an earlier time period) and items relating to goals 5 and 6, e.g., for which learning may have been presented last or otherwise during a later time period).

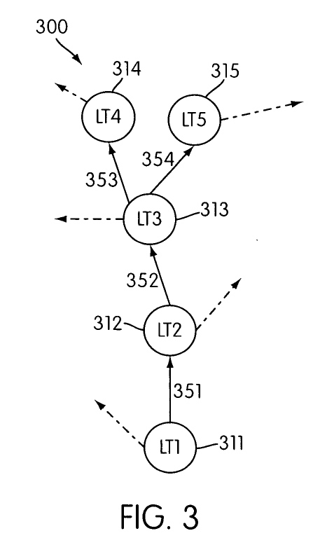

FIG. 2b illustrates a further item selection mechanism that utilizes a learning map or other diagnostic criteria. A more detailed example of a learning map is illustrated by FIG. 3. As shown in the learning map embodiment of FIG. 3, a learning map 300 may includes a set of nodes 311-315 representing learning targets LT1-LT5, respectively. Learning map 300 also includes arcs 351-354, which illustrate learning target postcursor/precursor relationships. The dashed arcs represent that map 300 may comprise portion of a larger map. In more specific embodiments, the learning maps may include directed, acyclic graphs. In other words, learning map arcs may be unidirectional and a map may include no cyclic paths.

In one embodiment, each learning target represents or is associated with a smallest targeted or teachable concept (“TC”) at a defined level of expertise or depth of knowledge (“DOK”). A TC may include a concept, knowledge state, proposition, conceptual relationship, definition, process, procedure, cognitive state, content, function, anything anyone can do or know, or some combination. A DOK may indicate a degree or range of degrees of progress in a continuum over which something increases in cognitive demand, complexity, difficulty, novelty, distance of transfer of learning, or any other concepts relating to a progression along a novice-expert continuum, or any combination of these.

For example, learning target 311 (LT1) represents a particular TC (i.e., TC-A) at a particular depth of knowledge (i.e., DOK-1). Learning target 312 (LT2), represents the same TC as learning target 311, but at a different depth of knowledge. That is, learning target 312, represents TC-A at a depth of knowledge of DOK-2. Arc 351, which connects target 311 to 312, represents the relationship between target 311 and 312. Because arc 351 points from target 311 to target 312, target 311 is a precursor to target 312, and target 312 is a postcursor of target 311.

Examples of learning maps and methods of developing them and using them to guide assessment and instructions are described in U.S. patent application Ser. No. 10/777,212, corresponding to application publication no. US 2004-0202987, the contents of which are hereby incorporated by reference.

Returning now to FIG. 2b, because each node in learning map 202 is a precursor to its successive node (e.g., node 221 to node 222, node 222 to node 223, and so on) and each successive node is a postcursor to its preceding node (e.g., node 224 to node 223, node 223 to node 222, and so on), a first item that includes a goal that corresponds to a first node (e.g., 222) is necessarily related to a successive item that includes a goal that corresponds to a first node precursor or postcursor (e.g., 221 and 223 respectively). Thus, for example, selection engine 116b (FIG. 1a) may receive indicators indicating learning map references (to nodes) corresponding to item-2, form A, item-1, form-A and item-1, form-B. Selection engine 116b may further compare the reference and determine from the comparison and the precursor/postcursor relationship that item-2, form A is related to item-1, form-A and item-1, form-B. Other selections may also be similarly made by reference to a learning map or as a function of diagnostic criteria provided by a learning map. Cluster analysis may, for example, also be used to identify items forming a related group and the relationship indicated may be defined or otherwise resolved by reference to a corresponding learning map.

Continuing with FIG. 2c, related items may also be selected by reference to a scale 203, such as a norm reference test scale (NRT), criterion reference scale (CRT), standard or other scale. For example, received criteria indicating that a task is related to a goal that is represented by a location on a scale or other normalized reference is necessarily related to another task indicated as being related to a goal that is represented on the same scale. Thus, for example, selection engine 116b (FIG. 1a) may receive criteria including indicators indicating scales with which goals corresponding to items 231 through 234 (and thus items 231 through 234) are represented (see FIG. 2c) and compare the corresponding scales to determine that items 231 through 234 are related items.

Returning again to FIG. 1a, mutual maximum likelihood engine (“likelihood engine”) 116c provides for determining, for the included assessments (and thus, also for the include items corresponding to the included assessments) a maximum likelihood ability estimate. More specifically, likelihood engine 116c provides for scoring the included assessments to produce the maximum likelihood ability estimate.

For example, let us assume that an assessment A that includes items a1, a2 . . . aN is administered at a time T1 and scored (e.g., by assessment engine 116a) to produce an ability estimate (θ1) given by equation 1, in which:
θ₁=f(AssessmentA) at T₁ Equation 1
Function, f, of equation 1 may, for example, represent a standardized ability estimate measure, which, in the implementation of the invention described herein, comprises a first, or greater, order probabilistic model that predicts an unobserved state (i.e., ability estimate) based on observed evidence (e.g., item response results), often referred to in the literature as “reasoning over time.” Typical examples of such models include unidimensional item response theory models (e.g., 3-parameter logistic model (3PL IRT), 2-parameter logistic model (2PL IRT), 1-parameter logistic model (1 PL IRT), Rasch model), multidimensional IRT models (MIRT), Learning Map Analytics (LMA), and Bayesian Networks. Let us further assume that an assessment B that includes items b₁, b₂ . . . b_{M} is administered at a time T₂ and scored (e.g., by assessment engine 116a) to produce an ability estimate (θ2) given by equation 2, in which:
θ₂=f(AssessmentB) at T₂ Equation 2

Again, for equation 2, the function f is a probabilistic model for predicting, or estimating, ability based on assessment results.

If selection engine 116b further selects related items included in included assessments A and B, then likelihood engine 116c may score the included assessments in accordance with a union of the ability estimates representing the greater number of items corresponding to the union of the assessments as compared with either individual included assessment. Moreover, likelihood engine 116c may score the included assessments to produce a maximum likelihood, or further, a simultaneous maximum likelihood ability estimate for the included assessments given by Equation 3 for theta 2 prime (θ2′) and theta 1 prime (θ1′) in which:
θ₂′=f(Assessment A in view of Assessment B), and
θ₁′=f(Assessment B in view of Assessment A). Equation 3
Stated alternatively, a standard measurement, such as 3PL IRT, which is given by equation 4 below, may be modified by the union of included ability estimates at a point of maximum likelihood for each one (here, θ₂′ and θ₁′) to produce a more accurate ability estimate at the time of each of the included assessments. For clarity sake, Equation 4 is expressed in a more conventional manner according to the probability of a correct response to item j by student i, wherein:
Pᵢⱼ(Xⱼ=1|θᵢ)=cⱼ+1−cⱼ/1+e^{-a}ⱼ^{(θ}^{ᵢ}^{-b}^{ⱼ₎} Equation 4

Where

Xⱼ=1 indicates a correct response to item j,

θᵢ is the ability estimate for student i, and

aⱼ, bⱼ, and cⱼ are the discrimination, difficulty, and pseudo-guessing parameters for the 3PL model, respectively.

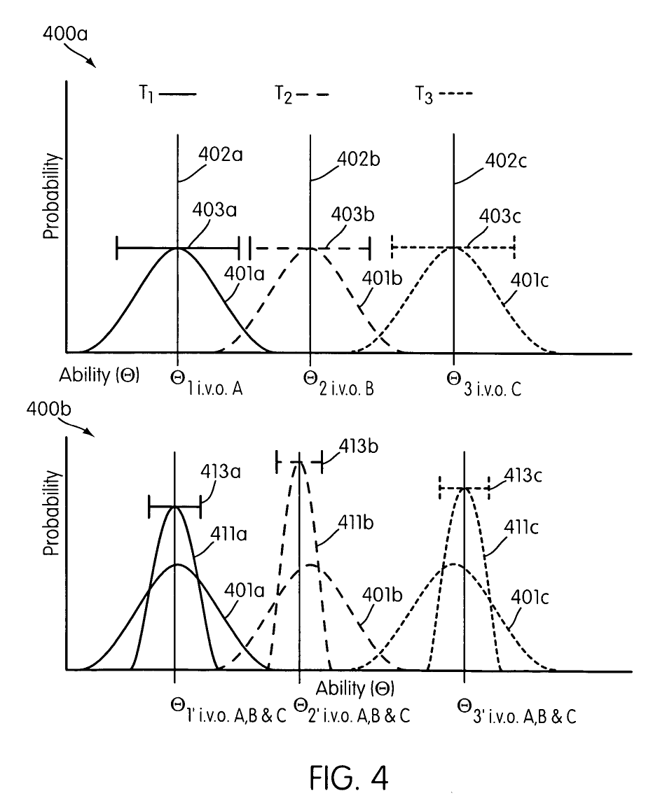

Graphs 400a and 400b of FIG. 4 further illustrate how the operation of likelihood engine 116c provides for increasing the accuracy of an ability estimate in an accumulate-able manner in conjunction with greater numbers of included assessments, according to an embodiment of the invention. The accumulation of three assessments is illustrated in this example given by the three sets of curves that are aligned by their respective thetas 402a-c. Probability versus ability graph 400a illustrates the probability of a student's ability given their response patterns to assessments A, B and C taken at times T1, T2, and T3 respectively. Curves 401a-c, represent the likelihood of the ability of the student for each assessment A-C taken individually (i.e. each in view of or i.v.o. itself). Each curve has a relatively broad slope and thus relatively large error 403a-c in the estimate of ability 402a-c. Through the application of cumulative assessment of the included assessments, however (400b), the slope and probability are substantially increased for each of the included assessments (411a-c) while the error is substantially reduced (413a-c). Stated alternatively, θ1′ in view of assessments A, B and C is far more accurate than θ1, which is taken only in view of itself. The same result is also achieved for θ2′ and θ3′ when taken in view of assessments A, B and C. Interpretation or other utilization of the included assessments is also greatly improved. For example, conventional assessment may lead to an erroneous conclusion that the student is making adequate progress at time T2 or that the student is in the proficient category rather than the advanced category at time T3. The ability estimates θ1′, θ2′ and θ3′ taken in view of all of the included assessments, however, the interested parties would be able to more accurately understand the progress of the student towards proficiency at T1 and T2 and measure proficiency more accurately at T3.

Returning now to FIG. 3, cumulative assessment may in one embodiment be conducted by likelihood engine 116c (FIG. 1) in accordance with a learning map. For example, assessment A, item a1 may measure learning target LT1 311, item a2 may measure LT2 312, assessment B, item b1may measure learning target LT3 313 and item b2 may measure LT4 314. The relationship between the items may be determined according to a precursor-postcursor relationship existing between the learning targets to which the items correspond. Assume, for example, that a student item response scores for the related items for assessment A and B as follows. (We further assume, for purposes of the present example, that a response may only be scored as completely correct or completely incorrect. In other embodiments, variable deviation from a correct response may also be scored as a substantiality of correctness or incorrectness, whereby partial credit or other finer granularity of assessment or some combination may be used.) For the present example, we assume that a1=incorrect (or 0), a2=correct (or 1), b1=correct and b2=correct. When assessment A is scored in view of assessment B, the ability estimate for LT1 311 is increased due to the confirmatory evidence from the item responses, b1 and b2, postcursors of LT1. The error in the ability estimate for LT1 311 is also reduced by the increase in evidence. Similarly, an assessment C (not shown) with items postcursor to LT1 311 may increase the ability estimate, and reduce the error in the estimate of ability for LT3 313 and LT4 314, assuming positive evidence of postcursor knowledge is obtained from assessment C.

The FIG. 1b flow diagram illustrates a further graphic item cumulative assessment system (“assessment system”) 100b according to an embodiment of the invention. As shown, system 100b is operable in a similar manner as with system 100a of FIG. 1a. System 100b, however, additionally provides for conducting automatic or user-assisted assessment of test materials that may be provided in electronic, hard-copy, combined or mixed forms, or for returning assessment results to a test site, individual users, groups, and so on, or some combination in electronic, hard-copy, combined or mixed forms, among other features.

System 100b includes assessment provider system 101 and test site system 102, which systems are at least intermittently communicatingly couplable via network 103. As with system 100a, test materials may be generated by test generation system 113a, e.g., via a learning map or other diagnostic criteria, by hand, using other mechanisms or some combination, and delivered to test site 102a1 or other test sites in hard-copy form, for example, via conventional delivery. The test may further be administered in hard-copy form at various locations within one or more test sites and the responses or other materials may be delivered, for example, via conventional delivery to performance evaluation system 111a of assessment provider system 100a. In other embodiments, test materials, results or both may be deliverable in hard-copy, electronic, mixed or combined forms respectively via delivery service 104, network 103 or both. (It will be appreciated that administering of the assessment may also be conducted with respect to remotely located students, in accordance with the requirements of a particular implementation.

Assessment (i.e., Test) generation system 113a in the embodiment of FIG. 1B includes item/assessment producing device 114a (e.g., printer, audio/video renderer, and so on, or some combination). Assessment generation system 113a may be further coupled, e.g., via a local area network (LAN) or other network 112a, to a server 115a. Assessment generation system 113a is also coupled (via network 112a) to performance evaluation system 111a and item response receiving device 110a (e.g., a scanner, renderer, other data entry device or means, or some combination). Assessment provider system 101b may further include a system 117a for document support and/or other services, also connected, via network 112a, to assessment provider server computer 115a.

Substantially any devices that are capable of presenting testing materials and receiving student responses (e.g., devices 124, 125) may be used by students (or officiators) as testing devices for administering an assessment in electronic form. Devices 124, 125 are connected at test site 102a1 via site network 123 (e.g., a LAN) to test site server computer 126. Network 103 may, for example, include a static or reconfigurable wired/wireless local area network (LAN), wide are network (WAN), such as the Internet, private network, and so on, or some combination. Firewall 118 is illustrative of a wide variety of security mechanisms, such as firewalls, encryption, fire zone, compression, secure connections, and so on, one or more of which may be used in conjunction with various system 100b components. Many such mechanisms are well known in the computer and networking arts and may be utilized in accordance with the requirements of a particular implementation.

As with system 100a, assessment provider 101a portion of assessment system 100b in one embodiment comprises performance evaluation engine 111a including a test material receiving device 110a and a cumulative assessment engine 116. Test material receiving device 110a may also again include a high-speed scanner, brail reader or other mechanism for receiving one or more response portions (e.g., of an answer book or mixed item-and-response format assessment sheet) and providing included item responses in an electronic format to other subject assessment system components. (It will be appreciated, however, that no conversion to electronic form may be required for responses or other utilized test materials that are received in electronic form.)

Performance evaluation system 111a of the illustrated embodiment includes a Cumulative assessment engine 116 that provides for performing cumulative assessment in a substantially similar manner as discussed for cumulative assessment engine 116 of FIG. 1a. Assessment engine 116a may provide for assessing received tests, assessment item selection engine 116b may provide for selecting included assessments or items and likelihood engine 116c may provide for producing a maximum likelihood ability estimate for the included assessments as was discussed with reference to corresponding components of cumulative assessment engine 116 of FIG. 1a.

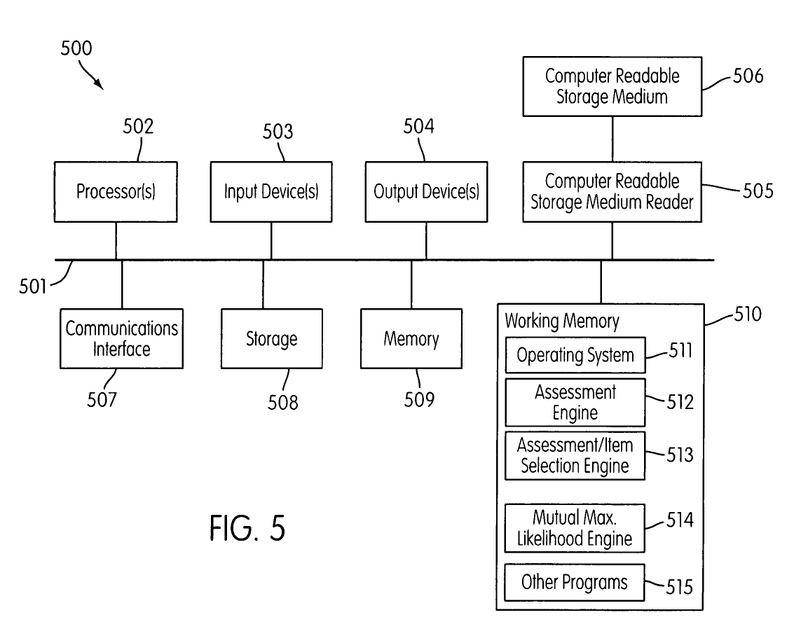

The FIG. 5 flow diagram illustrates a computing system embodiment that may comprise one or more of the components of FIGS. 1a and 1b. While other alternatives may be utilized or some combination, it will be presumed for clarity sake that components of systems 100a and 100b and elsewhere herein are implemented in hardware, software or some combination by one or more computing systems consistent therewith, unless otherwise indicated or the context clearly indicates otherwise.

Computing system 500 comprises components coupled via one or more communication channels (e.g. bus 501) including one or more general or special purpose processors 502, such as a Pentium®, Centrino®, Power PC®, digital signal processor (“DSP”), and so on. System 500 components also include one or more input devices 503 (such as a mouse, keyboard, microphone, pen, and so on), and one or more output devices 504, such as a suitable display, speakers, actuators, and so on, in accordance with a particular application.

System 500 also includes a computer readable storage media reader 505 coupled to a computer readable storage medium 506, such as a storage/memory device or hard or removable storage/memory media; such devices or media are further indicated separately as storage 508 and memory 509, which may include hard disk variants, floppy/compact disk variants, digital versatile disk (“DVD”) variants, smart cards, partially or fully hardened removable media, read only memory, random access memory, cache memory, and so on, in accordance with the requirements of a particular implementation. One or more suitable communication interfaces 507 may also be included, such as a modem, DSL, infrared, RF or other suitable transceiver, and so on for providing inter-device communication directly or via one or more suitable private or public networks or other components that can include but are not limited to those already discussed.

Working memory 510 further includes operating system (“OS”) 511, and may include one or more of the remaining illustrated components in accordance with one or more of a particular device, examples provided herein for illustrative purposes, or the requirements of a particular application. Assessment engine 512, selection engine 513 and likelihood engine 514 may, for example, be operable in substantially the same manner as was already discussed. Working memory of one or more devices may also include other program(s) 515, which may similarly be stored or loaded therein during use.

The particular OS may vary in accordance with a particular device, features or other aspects in accordance with a particular application, e.g., using Windows, WindowsCE, Mac, Linux, Unix, a proprietary OS, and so on. Various programming languages or other tools may also be utilized, such as those compatible with C variants (e.g., C++, C#), the Java 2 Platform, Enterprise Edition (“J2EE”) or other programming languages. Such working memory components may, for example, include one or more of applications, add-ons, applets, servlets, custom software and so on for conducting cumulative assessments including, but not limited to, the examples discussed elsewhere herein. Other programs 515 may, for example, include one or more of security, compression, synchronization, backup systems, groupware, networking, or browsing code, and so on, including but not limited to those discussed elsewhere herein.

When implemented in software, one or more of system 100a and 100b or other components may be communicated transitionally or more persistently from local or remote storage to memory (SRAM, cache memory, etc.) for execution, or another suitable mechanism may be utilized, and one or more component portions may be implemented in compiled or interpretive form. Input, intermediate or resulting data or functional elements may further reside more transitionally or more persistently in a storage media, cache or other volatile or non-volatile memory, (e.g., storage device 508 or memory 509) in accordance with the requirements of a particular application.

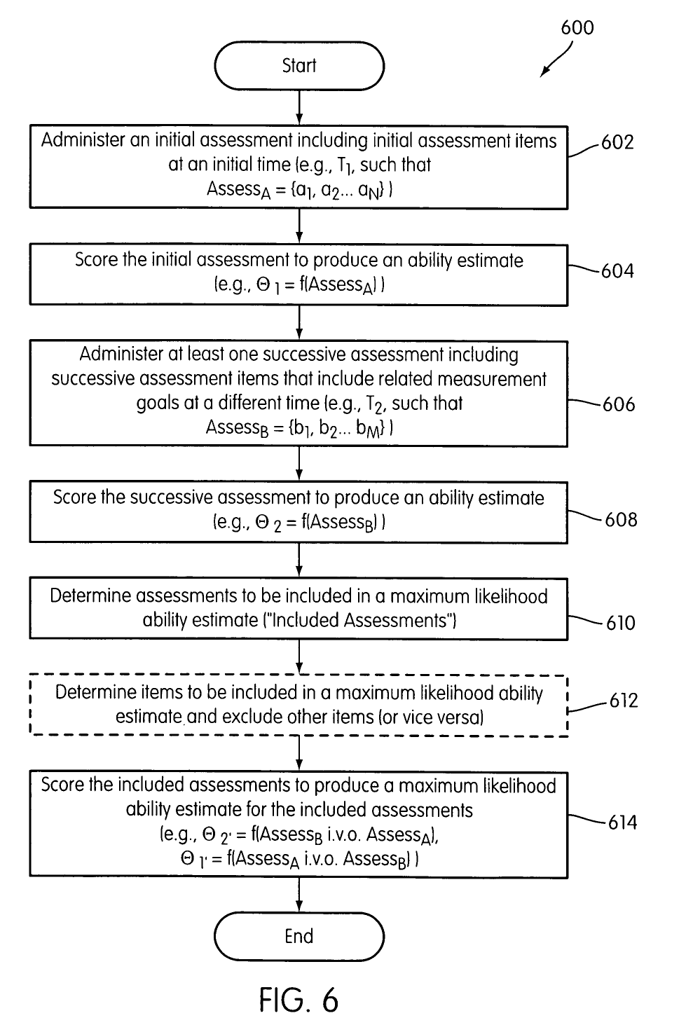

Turning now to FIG. 6, a cumulative assessment method 600 is illustrated according to an embodiment of the invention that may, for example, be performed by a cumulative assessment engine. In block 602 the cumulative assessment engine administers an initial assessment including initial assessment items at an initial time, T1. In block 604, the cumulative assessment engine scores the initial assessment to produce an ability estimate, θ1. In block 606, the cumulative assessment engine administers at least one successive assessment including successive assessment items that may include items corresponding to related measurement goals at a different time than the initial assessment, T2. (Note, however, that the assessments may include portions of a same assessment, which may also be administered at different times, e.g., T1 and T2.) In block 608, the cumulative assessment engine scores the successive assessment to produce an ability estimate, θ2.

In block 610, the cumulative assessment engine determines included assessments, and in block 612, determines included items (e.g., directly or via determination of excluded items). In block 614, the cumulative assessment engine scores the included assessments (or included items of the included assessments) to produce a maximum likelihood ability estimate for the included assessments.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for generating an ability estimate for an assessment subject comprising:
administering to the assessment subject a first assessment at a first time T1, the first assessment including one or more items;
scoring responses by the assessment subject to the items of the first assessment;
administering to the assessment subject one or more subsequent assessments at one or more subsequent times T₂- T_{N}, each subsequent assessment including one or more items;
scoring responses by the assessment subject to the items of each of the subsequent assessments;
selecting a group of included items comprising one or more items from said first assessment and one or more items from each of at least one of said subsequent assessments, wherein the included items are related to the ability being estimated; and
computing an ability estimate for the assessment subject at any time of the administered assessments T₁-T_{N} based on scores of the group of included items.

2. The method of claim 1, wherein the selecting step comprises applying predetermined selection criteria for selecting the included items.

3. The method of claim 1, wherein the included items are associated with learning targets of a learning map that share pre-cursor or post-cursor relationships with each other.

4. The method of claim 1, wherein the selecting step includes cluster analysis for identifying items forming a related group of items.

5. The method of claim 4, further comprising utilizing a learning map having learning targets with which the related group of items are associated to determine relationships between items within the related group of items.

6. The method of claim 1, wherein the selecting step is performed by reference to a scale on which the included items are represented.

7. The method of claim 1, wherein the ability estimate is computed using a probabilistic model that predicts an ability estimate based on item response results.

8. The method of claim 7, wherein the probabilistic model comprises a modeling function selected from the group comprising unidimensional item response theory models, multidimensional IRT models, Learning Map Analytics, and Bayesian Networks.

9. The method of claim 8, wherein the unidimensional item response theory models comprise a model selected from the group comprising: 3-parameter logistic model, 2-parameter logistic model, 1-parameter logistic model, and Rasch model.

10. The method of claim 1, wherein said first and subsequent assessments are administered as paper-based assessments on which students are instructed to provide hand-written responses to assessment items.

11. The method of claim 10, further comprising converting the hand-written responses into computer-readable data.

12. The method of claim 1, wherein said first and subsequent assessments are administered as computer-based assessments on which students are instructed to enter responses to assessment items on a computer input device.

13. A system for generating an ability estimate for an assessment subject comprising:
a test administration module adapted to administer to the assessment subject a first assessment at a first time T₁, the first assessment including one or more items, and to administer to the assessment subject one or more subsequent assessments at one or more subsequent times T₂-T_{N}, each additional assessment including one or more items;
a scoring module adapted to score responses by the assessment subject to the items of the first and subsequent assessments;
an item selection module adapted to select a group of included items comprising one or more items from said first assessment and one or more items from each of at least one of said additional assessments, wherein the included items are related to the ability being estimated; and
an ability estimate engine adapted to compute an ability estimate for the assessment subject at any time of the administered assessments T₁-T_{N} based on scores of the group of included items.

14. The system of claim 13, wherein said test administration module comprises an assessment presentation device and a user input device adapted to enable the assessment subject to input responses to items.

15. The system of claim 14, wherein said presentation device comprises one or more of a display monitor, speakers, and actuators, and said user input device comprises one or more of a mouse, keyboard, microphone, and pen.

16. A method for generating a cumulative ability estimate for an assessment subject comprising:
administering to the assessment subject an initial assessment at an initial time, the initial assessment including initial assessment items;
generating an initial ability estimate for the assessment subject for the initial time based on responses to the initial assessment items related to the ability being estimated;
administering to the assessment subject at least one successive assessment at a time different from the initial time, the successive assessment including successive assessment items including items having measurement goals that are related to measurement goals of the initial assessment items;
generating a successive ability estimate for the assessment subject for the different time based on responses to the successive assessment items related to the ability being estimated;
selecting two or more assessments of the initial and at least one successive assessment to be included in an improved likelihood ability estimate;
selecting assessment items from the two or more selected assessments to be included in the improved likelihood ability estimate and excluding non-selected items from the improved likelihood ability estimate; and
generating improved likelihood ability estimates for the assessment subject for the initial time and for the different time based on the responses to the selected assessment items.

17. The method of claim 16, wherein each of the items of the initial and successive assessments correspond with at least one learning target of a learning map and wherein items are selected to be included in the improved likelihood ability estimate according to precursor-postcursor relationships existing between learning targets to which the items correspond.

18. The method of claim 16, wherein the ability estimates are computed using a probabilistic model that predicts an ability estimate based on item response results.

19. The method of claim 16, wherein said initial and successive assessments are administered as paper-based assessments on which students are instructed to provide hand-written responses to assessment items.

20. The method of claim 19, further comprising converting the hand-written responses into computer-readable data.

21. The method of claim 16, wherein said initial and successive assessments are administered as computer-based assessments on which students are instructed to enter responses to assessment items on a computer input device.

22. The method of claim 18, wherein the probabilistic model comprises a modeling function selected from the group comprising unidimensional item response theory models, multidimensional IRT models, Learning Map Analytics, and Bayesian Networks.

23. The method of claim 22, wherein the unidimensional item response theory models comprise a model selected from the group comprising: 3-parameter logistic model, 2-parameter logistic model, 1-parameter logistic model, and Rasch model.
